(19) United States
(12) Patent Application Publication
(10) Pub. No.: US 2025/0303288 A1
(43) Pub. Date: Oct. 2, 2025

(54) INFORMATION PROCESSING DEVICE, INFORMATION PROCESSING SYSTEM, METHOD FOR CONTROLLING INFORMATION PROCESSING DEVICE, AND PROGRAM

(71) Applicant: Sony Interactive Entertainment Inc., Tokyo (JP)

(72) Inventors: Hideki MORI, Tokyo (JP); Masaomi NISHIDATE, Tokyo (JP); Hiroya MATSUGAMI, Tokyo (JP)

(73) Assignee: Sony Interactive Entertainment Inc., Tokyo (JP)

(21) Appl. No.: 19/104,366

(22) PCT Filed: Aug. 25, 2022
(86) PCT No.: PCT/JP2022/032117

§ 371 Date: Feb. 18, 2025

(51) Int. Cl. A63F 13/52; G06T 19/20

(52) U.S. Cl. CPC A63F 13/52; G06T 19/20; G06T 2219/024; G06T 2219/2004; G06T 2219/2016

(57) ABSTRACT

Provided is an information processing device that is connected to a display device of a first type and that is communicably connected to another information processing device which is connected to a display device of a type different from the display device of the first type. The information processing device includes a processor which accesses setting information regarding a virtual space shared with the other information processing device, executes a process of arranging a virtual character in the virtual space represented by the setting information, and, in the process of arranging the virtual character, arranges the virtual character by using a parameter determined according to the type of the display device connected to the information processing device.

### TECHNICAL FIELD

The present invention relates to information processing devices connected to display devices, respectively, an information processing system including the information processing devices, a control method for the information processing devices, and a program.

### BACKGROUND ART

Conventionally, television devices, liquid crystal display monitors, etc., have been used as display devices for, for example, home video game consoles. However, in recent years, various types of display devices have begun to be used, such as virtual reality (VR) display devices using head mounted displays (HMDs) and stereoscopic displays that display stereoscopic images.

### SUMMARY

### Technical Problem

However, in the case of playing a game of the same title on a home video game console or the like, for example, the characters controlled by users are the same regardless of the type of the display devices to be used, and the current situation is that the users cannot play in a way that suits the display devices of the users.

The present invention has been made in consideration of the above-mentioned situation, and one of its objectives is to provide an information processing device, an information processing system, a control method for the information processing device, and a program that enable play according to the display device owned by the user.

### Solution to Problem

One aspect of the present invention that solves the problem of the conventional examples described above is an information processing device that is connected to a display device of a first type and that is communicably connected to another information processing device which is connected to a display device of a type different from the display device of the first type, and includes a processor. The processor accesses setting information regarding a virtual space shared with the other information processing device, executes a process to arrange a virtual character in the virtual space represented by the setting information, and arranges the virtual character by using a parameter that is determined according to the type of the display device connected to the information processing device, in the process of arranging the virtual character.

### Advantageous Effect of Invention

According to the present invention, a user can play a game according to the display device that the user owns.

### BRIEF DESCRIPTION OF DRAWINGS

FIG. 1 is a block diagram illustrating an example of a configuration of an information processing system according to an embodiment of the present invention.

FIG. 2 is a schematic block diagram illustrating an example of a display device connected to the information processing device according to the embodiment of the present invention.

FIG. 3 is a schematic block diagram illustrating another example of the display device connected to the information processing device according to the embodiment of the present invention.

FIG. 4 is a functional block diagram illustrating an example of the information processing device according to the embodiment of the present invention.

### DESCRIPTION OF EMBODIMENT

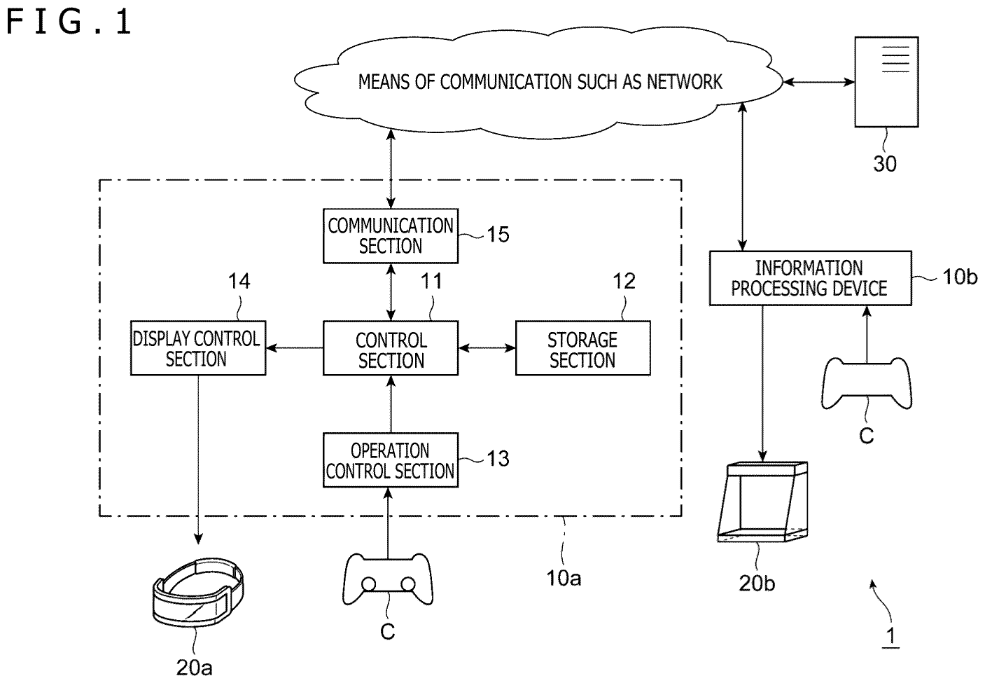

An embodiment of the present invention will be described with reference to the drawings. As illustrated in FIG. 1, an information processing system 1 according to an example of the embodiment of the present invention includes a plurality of information processing devices 10a, 10b, and display devices 20a, 20b, . . . , connected to the information processing devices 10a, 10b, . . . , respectively. In addition, each information processing device 10 (hereinafter, in the case of not distinguishing between the individual devices, the information processing devices will simply be referred to as information processing devices 10, for example, without the suffixes a, b, . . . ) are connected to each other to be communicable with each other via a network. Further, the information processing device 10 may be connected to a server device 30 to be communicable with each other via a network.

Here, the display devices 20a, 20b, . . . connected to the plurality of information processing devices 10a, 10b, . . . , respectively, include at least two or more types of display devices. For example, the display device 20a connected to one information processing device 10a may be a VR display device using an HMD, and the display device 20b connected to another information processing device 10b may be a stereoscopic display. Hereinbelow, the information processing devices 10 are all described as home video game consoles, but the present embodiment is not limited to these.

As illustrated in FIG. 1, the information processing devices 10 each include a control section 11, a storage section 12, an operation control section 13, a display control section 14, and a communication section 15.

Here, the control section 11 is a program-controlled device such as a central processing unit (CPU), and operates according to a program stored in the storage section 12. In an example of the embodiment of the present invention, the control section 11 accesses setting information regarding a virtual space shared with another information processing device 10, and executes a process of arranging a virtual character in the virtual space represented by the setting information. Further, in the process of arranging the virtual character, the control section 11 arranges the virtual character by using parameters determined according to the type of the display device 20 connected to the information processing device 10 including the control section 11 itself. The detailed operation of the control section 11 will be described later.

The storage section 12 is a memory device, a disk device, or the like, and holds a program to be executed by the control section 11. This program may be provided by being stored in a computer-readable and non-transitory recording medium, and may be copied to the storage section 12. Further, the storage section 12 also operates as a work memory for the control section 11.

The operation control section 13 accepts an instruction from a user and outputs information representing the contents of the instruction to the control section 11. To be specific, the operation control section 13 is communicably connected to a controller device C operated by the user, and accepts an instruction represented by operations performed by the user on the controller device C. Then, the operation control section 13 outputs information representing the contents of the instruction to the control section 11.

The display control section 14 is a display controller or the like, and instructs the display device 20 connected to the information processing device 10 itself to display an image in accordance with an instruction input from the control section 11. For example, in a case where the display device 20 connected to the information processing device 10 itself is a VR display device, the display control section 14 generates an image for the left eye and an image for the right eye in accordance with an instruction input from the control section 11 and outputs the images to the display device 20. Further, if the display device 20 connected to the information processing device 10 itself is a stereoscopic display for stereoscopic vision, the display control section 14 generates information in a format predetermined for each display device 20 for displaying an image for stereoscopic vision on the display device 20, in accordance with an instruction input from the control section 11, and outputs the information to the display device 20.

The communication section 15 is a network interface or the like, and transmits information to another information processing device 10 and the server device 30 via the network in accordance with an instruction input from the control section 11. In addition, the communication section 15 also outputs information received from another information processing device 10 or the server device 30 via the network to the control section 11.

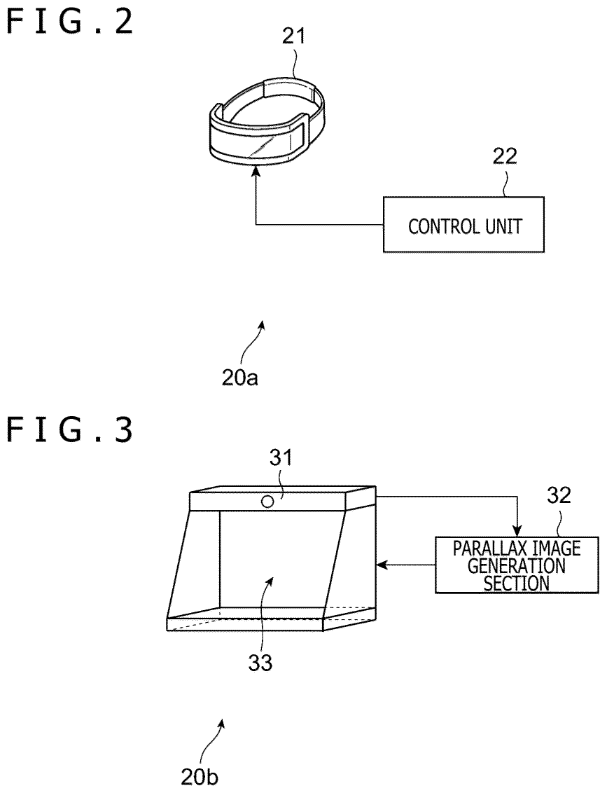

In this example, as already described, the display device 20a connected to the information processing device 10a is a VR display device, and includes an HMD 21 and a control unit 22, as illustrated in FIG. 2.

The HMD 21 is a head-mounted display that is worn on the user's head, and has a display for the left eye and a display for the right eye, to output images for the left eye and right eye input from the control unit 22, for display on the corresponding displays.

The control unit 22 receives the images for the left eye and the right eye from the information processing device 10a, performs predetermined processing on the images, and outputs the images to the HMD 21.

In addition, the display device 20b connected to the information processing device 10b is a stereoscopic display, and includes a viewpoint detection unit 31, a parallax image generation section 32, and a parallax image display section 33, as illustrated in FIG. 3.

The viewpoint detection unit 31 includes a camera, and uses this camera to recognize the positions of the user's eyes located in front of the display device 20b, and outputs information regarding the user's eye positions obtained through this recognition to the parallax image generation section 32.

The parallax image generation section 32 generates image data for display on the parallax image display section 33 such that an image for the left eye and an image for the right eye are visually recognized at the positions of the user's left and right eyes input from the information processing device 10b, respectively.

The parallax image display section 33 includes a display device and a lenticular lens overlaid thereon, and outputs the image data generated by the parallax image generation section 32, for display on the display device. As a result, the image for the left eye and the image for the right eye are visually recognized at the positions of the left and right eyes of the user detected by the viewpoint detection unit 31, respectively. Such a display device 20b, which is a stereoscopic display, is widely known, and thus, further detailed description of its configuration and operation will be omitted.

It should be noted that these display devices 20 are merely examples, and various other display devices 20 may be used.

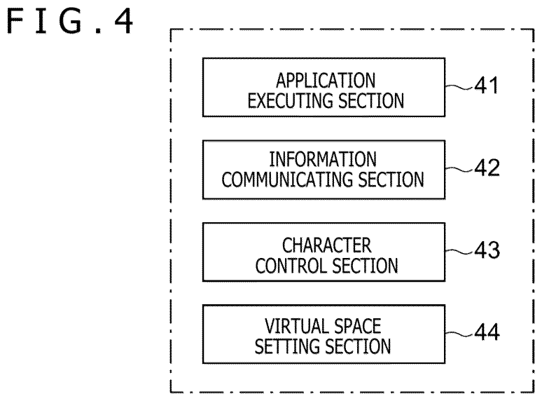

Next, a description will be given of the operation of the control section 11 of the information processing device 10. In the present embodiment, the control section 11 includes an application executing section 41, an information communicating section 42, a character control section 43, and a virtual space setting section 44, as exemplified in FIG. 4.

The application executing section 41 executes the processing of an application designated by a user. As a specific example, the application to be executed is a game application to be played jointly by users of the plurality of information processing devices 10 connected via a network.

The application executing section 41 in this example performs a process of arranging a virtual character controlled by the user, in a virtual three-dimensional game space (virtual space) shared among the plurality of information processing devices 10 via the server device 30, and a process of allowing the user to operate the virtual character arranged in the virtual space to control its position and pose, and allows the user to play a game.

The information communicating section 42 according to this example of the present embodiment transmits and receives information to and from the server device 30, and acquires setting information regarding a virtual space shared with another information processing device 10. This virtual space is a three-dimensional game space, for example, and the setting information includes information representing the shapes, positions, and poses of objects and virtual characters arranged in the game space. Here, for the pose of a virtual character, information regarding the angle of the head, the angle of each joint of the arms, and the angle of each joint of the legs is included, in a case where the virtual character has a head, a torso, arms, and legs, for example.

In accordance with an instruction for arranging a virtual character input from the application executing section 41, the character control section 43 arranges a predetermined virtual character in the virtual space represented by the setting information acquired by the information communicating section 42, by using parameters determined according to the type of the display device 20 connected to the information processing device 10 itself, and updates the setting information.

In one example of the present embodiment, a parameter related to the body size of the virtual character in the virtual space is included in the parameters determined according to the type of the display device 20. In this example, the server device 30 stores in advance a parameter database (which may be common to all information processing devices 10) in which a parameter of information indicating the type of the display device 20 connected to the information processing device 10 is associated with a parameter of information indicating the body size of the virtual character or the like.

In one example of the present embodiment, in this parameter database, “1” as information indicating the size of the body of a virtual character is associated with information indicating that the type of the display device 20 is a “VR display device,” and “100” as information indicating the size of the body of a virtual character is associated with information indicating that the type of the display device 20 is a “stereoscopic display,” for example. In this example, this means that the body size of a virtual character controlled by a user of the information processing device 10 connected to a stereoscopic display is 100 times as big as that of a virtual character controlled by a user of the information processing device 10 connected to a VR display device.

Further, this parameter database may further include movable area information representing the area in the virtual space in which the virtual character can move, in addition to information representing the body size of the virtual character as a parameter, in association with the type of the display device 20.

When receiving an input of an instruction for arranging a virtual character from the application executing section 41, the character control section 43 acquires information indicating the type of the display device 20 connected to the information processing device 10 itself. Further, the character control section 43 acquires parameters of the body size and movable area information regarding the virtual character in the virtual space, which are stored in the parameter database in association with the acquired information.

The character control section 43 arranges a virtual character of the acquired size randomly, for example, in the area in the virtual space represented by the acquired movable area information. Then, the character control section 43 instructs the virtual space setting section 44 to set the position of the virtual character which is under control of the character control section 43 to the above-described arrangement position in the virtual space information held by the server device 30.

Further, the character control section 43 receives instructions for controlling the position and pose of the virtual character from the application executing section 41, and executes processing as follows.

The character control section 43 calculates a position (x +Δx, y+Δy, z+Δz) in the virtual space to be obtained after the movement, when receiving an input of an instruction for moving the virtual character from the current position (x, y, z) in the virtual space by a vector quantity (Δx, Δy, Δz) representing a three-dimensional direction, which is a movement instruction for the virtual character from the application executing section 41. Then, the character control section 43 checks whether or not the position to be obtained after the movement is included in the area represented by the movable area information. Here, when the position to be obtained after the movement is included in the area represented by the movable area information, the character control section 43 moves the position of the virtual character to the position (x+Δx, y+Δy, z+Δz) in the virtual space, and instructs the virtual space setting section 44 to set the position of the virtual character which is under control of the character control section 43 to the above-described position to be obtained after the movement, in the virtual space information held by the server device 30.

On the other hand, when the position to be obtained after the movement is not included in the area represented by the movable area information, the character control section 43 does not move the position of the virtual character from the current position (x, y, z) in the virtual space, for example.

Besides, the character control section 43 receives an instruction for changing the pose of the virtual character (e.g., for raising an arm, changing the angle of the head, etc.) from the application executing section 41. For example, when an instruction is received to change the angle of the head from the current angle (θ, φ, ψ) by (Δθ, Δφ, Δψ) by using the angle θ around the normal direction of the coronal plane of the virtual character (front-back direction of the body), the angle φ around the normal direction of the transverse plane (up-down direction), and the angle ψ around the normal direction of the sagittal plane (i.e., elevation angle) (right-left direction), the character control section 43 obtains the changed angle (θ+Δθ, φ+Δφ, ψ+Δψ). The character control section 43 then changes the angle of the head of the virtual character to (θ+Δθ, φ+Δφ, ψ+Av), and instructs the virtual space setting section 44 to set the pose of the virtual character which is under control of the character control section 43 to the changed pose in the virtual space information held by the server device 30.

Incidentally, here, the indicated amount of movement (Δx, Δy, Δz) or amount of change in the pose (ΔΘ, Δφ, Δψ) is added at once, but the present embodiment is not limited to this, and a limit may be set on the amount of movement or change to be added at once. In this example, in a case where the indicated amount of movement (Δx, Δy, Δz) exceeds a predetermined limit (xlimit, ylimit, zlimit) (in a case where Δx>xlimit, Δy>ylimit, or Δz>zlimit), the character control section 43 corrects the amount of movement or change to be added at once to within the limited range to determine the amount of movement or change to be added at once, repeats the change in the pose or movement of the determined amount to be added at once, and makes the change of the pose or movement of the virtual character.

To be specific, in a case where the movement amount corresponding to the instruction exceeds the limit and this correction process is to be performed, the character control section 43 calculates δx=Δx−xlimit, δy=Δy−ylimit, and δz=Δz−zlimit by using the movement amount (Δx, Δy, Δz) corresponding to the above instruction and the limits (xlimit, ylimit, zlimit). The character control section 43 then uses the maximum value δp among δx, δy, and δz (p is any one of x, y, and z) to obtain T=[Δp/plimit]+1 (where [X] is the maximum integer not exceeding X).

Next, the character control section 43 calculates the position of the virtual character to be obtained after the movement (x+Δx×i/T, y+Δy×i/T, z+Δz×i/T) (the i-th movement position (i is an integer equal to or less than T)), for each predetermined time period by repeating T times, with the amount of change per one time being (Δx/T, Δy/T, Δz/T). The character control section 43 then checks whether or not the calculated position to be obtained after the movement is included in the area represented by the movable area information. Here, when the position to be obtained after the movement is included in the area represented by the movable area information, the character control section 43 moves the position of the virtual character to a position (x+Δx×i/T, y+Δy×i/T, z+Δz×i/T) in the virtual space, and instructs the virtual space setting section 44 to set the position of the virtual character which is under control of the character control section 43 to the above-described position to be obtained after the movement, in the virtual space information held by the server device 30.

On the other hand, when the position to be obtained after movement is not included in the area represented by the movable area information, the character control section 43 does not move the position of the virtual character from the movement position (x+Δx×k/T, y+Δy×k/T, z+Δz×k/T) (θ≤k<i) which is the last position indicated to the virtual space setting section 44, for example.

However, this is only one example, and any other method may be used as long as the above limit is not exceeded in one movement. For example, in a case where the indicated movement amount (Δx, Δy, Δz) exceeds the limit, the character control section 43 may use the above δx, δy, and δz to correct the movement amount in one movement to (Δx′, Δy′, Δz′) under the condition that
Δx′=δx (in the case of δx>0) or Δx (in the case of δx≤0),
Δy′=δy (in the case of δy>0) or Δy (in the case of δy≤0), and
Δz′=δz (in the case of δz>0) or Δz (in the case of δz≤0).

Further, in this example, when changing a parameter related to the body size of a virtual character, the character control section 43 may limit the amount of movement or change in accordance with whether or not the virtual character which is under control of the character control section 43 has a relatively large body size. That is, the character control section 43 may collect information regarding body size parameters of virtual characters controlled by another information processing device 10 that share the setting information regarding the virtual space to play a game (which is only required to be included in the setting information regarding the virtual space), and may limit the amount of movement or change given at one time, in a case where the body size of the virtual character which is under control of the character control section 43 is larger than the average body size of the virtual characters controlled by the other information processing device 10.

According to this example, for example, in a case where the display device 20a connected to one information processing device 10a is a VR display device that displays video from the perspective of a relatively small virtual character moving in a virtual space, and the display device 20b connected to the other information processing device 10b displays video from the perspective of a relatively large virtual character in a position overlooking the entire virtual space, it is possible to reduce the sense of strangeness felt by a user using the VR display device due to a virtual character which is in a position that the user looking up at and which is moving a relatively large amount or changing its pose by a relatively large amount per unit time.

When receiving, from the character control section 43, information indicating the position and pose in the virtual space of the virtual character that is the object of control of the character control section 43, the virtual space setting section 44 accesses the server device 30 to request rewriting that replaces the position and pose information relating to the virtual character that is the object of control of the character control section 43, which is included in the virtual space setting information held by the server device 30, with the position and pose information input from the character control section 43, and updating of the virtual space setting information.

### [Operation]

The information processing system 1 of the present embodiment basically has the above configuration and operates as follows. In the following example, it is assumed that users of the information processing devices 10a and 10b cooperate to play a game in which they handle tasks within a single game space managed by the server device 30. It is also assumed that the display device 20a connected to the information processing device 10a is a VR display device and that the display device 20b connected to the information processing device 10b is a stereoscopic display.

When a user of the information processing device 10a starts the application for the game, the information processing device 10a accesses the server device 30 and acquires setting information regarding the game space. It is assumed that this setting information has been prepared in advance, a stage of a predetermined size is arranged initially in a three-dimensional space, and virtual objects such as walls, tables, and items are arranged on this stage.

The information processing device 10a starts a process of arranging a virtual character in this game space. The information processing device 10a refers to a parameter database which is prepared in advance on the server device 30 side and which associates information indicating the type of the display device 20 connected to the information processing device 10 with a parameter of information indicating the body size of the virtual character, for example, and acquires a parameter of information indicating the body size of the virtual character and a parameter of movable area information indicating the movable area of the virtual character in the virtual space, for example, the pieces of information being associated with information representing the “VR display device” that is the display device 20a connected to the information processing device 10a.

Here, it is assumed that the information representing the body size of the virtual character acquired by the information processing device 10a indicates the size as “1” and that the area represented by the movable area information is on a stage arranged in the game space.

The information processing device 10a arranges a virtual character A of the acquired size randomly, for example, in the area of the virtual space represented by the acquired movable area information. Then, the information processing device 10a instructs the server device 30 to add information representing the arrangement position of the virtual character A and information representing the pose of the virtual character A (the initial pose may be determined in advance) to the setting information regarding the virtual space held by the server device 30.

The server device 30 then updates the setting information regarding the virtual space in accordance with this instruction.

Meanwhile, the information processing device 10a repeatedly acquires setting information regarding the virtual space from the server device 30 at predetermined timings, generates images (right-eye image and left-eye image) from the viewpoint of the arranged virtual character A in the virtual space represented by the setting information, and outputs the images for display on the display device 20a. This allows the user to visually recognize the images in the virtual space.

Further, the user operates the controller device C to give an instruction for movement of the position of virtual character A, for example. The information processing device 10a accepts this user's instruction and provisionally determines that virtual character A moves from the current position (x, y, z) of the virtual character A in the virtual space by a vector amount (Δx, Δy, Δz) that represents the three-dimensional direction as the indicated direction.

The information processing device 10a calculates the position (x+Δx, y+Δy, z+Δz) in the virtual space to be obtained after the movement, and checks whether or not this position to be obtained after the movement is included in the area represented by the movable area information. Here, when the position to be obtained after the movement is included in the area represented by the movable area information, the information processing device 10a moves the position of the virtual character to the position (x+Δx, y+Δy, z+Δz) in the virtual space, and requests the server device 30 to set the position of the virtual character which is under control of the information processing device 10a to the above-described position to be obtained after the movement, in the virtual space information held by the server device 30.

At a later timing, when the information processing device 10a acquires setting information regarding the virtual space from the server device 30 and generates images (images for the right eye and images for the left eye) from the viewpoint of the arranged virtual character A in the virtual space represented by the setting information, this image becomes an image of the virtual space as seen from the virtual character A located at the position (x+Δx, y+Δy, z+Δz) in the virtual space obtained after the movement.

On the other hand, when a user of the information processing device 10b starts the application of the game, the information processing device 10b also accesses the server device 30 and acquires setting information regarding the game space.

The information processing device 10b starts a process of arranging a virtual character in this game space, and refers to a parameter database prepared in advance on the server device 30 side, to acquire a parameter of information representing the body size of the virtual character and a parameter of the movable area information representing the area in which the virtual character can move in the virtual space, for example, the pieces of information being associated with information representing the “stereoscopic display” which is the display device 20b connected to the information processing device 10b.

Here, it is assumed that the information representing the body size of the virtual character acquired by the information processing device 10b indicates the size as “100” and that the area represented by the movable area information is a predetermined position outside the stage arranged in the game space.

The information processing device 10b arranges the virtual character B of the acquired size in a position that is an area in the virtual space represented by the acquired movable area information. Then, the information processing device 10b instructs the server device 30 to add information representing the arrangement position of a virtual character B and information representing its pose (the initial pose may be determined in advance) to the setting information regarding the virtual space held by the server device 30. Subsequently, the server device 30 updates the setting information regarding the virtual space in accordance with this instruction.

Meanwhile, the information processing device 10b repeatedly acquires setting information regarding the virtual space from the server device 30 at predetermined timings, generates images (right-eye image and left-eye image) from the viewpoint of the arranged virtual character B in the virtual space represented by the setting information, and outputs the images for display on the display device 20b. This allows the user to get an overhead view of the virtual space.

Further, at this time, the user of the information processing device 10a also visually recognizes a relatively large virtual character B (100 times as large as the size of the user) outside the stage of the virtual space.

The user of the information processing device 10b operates the controller device C connected to the information processing device 10b, to give an instruction to change the pose of the virtual character B (change the pose of the arms, hands, fingers, etc.), for example. The information processing device 10b accepts the user's instruction, changes the current information regarding the pose of the virtual character B in the virtual space, provisionally decides to change the angle of the arm (angle of the shoulder joint) from α to α+Δα, for example, on the basis of the instruction given by the user to instruct the virtual character B to point to a certain position on the stage with the fingertip of the virtual character B, for example, and requests the server device 30 to set the pose of the virtual character B which is under control of the information processing device 10b to the pose to be obtained after the change, in the information regarding the virtual space held by the server device 30. Further, the information processing device 10b also requests the server device 30 to change the pose regarding the angles of the wrist, fingers, etc., similarly in accordance with the user's instruction. Then, the server device 30 updates the setting information regarding the virtual space in accordance with these requests.

When the information processing device 10a acquires setting information regarding the virtual space from the server device 30 at subsequent timing and generates images (right-eye image and left-eye image) from the viewpoint of the arranged virtual character A in the virtual space represented by the setting information, it becomes possible to visually recognize that the virtual character B is pointing to a point on the stage. Then, the user of the information processing device 10a operates the controller C to instruct the information processing device 10a to move the position of the virtual character A controlled by the user in the direction of the point.

According to the information processing system 1 described above, for each information processing device 10, game processing is performed in such a manner that a virtual character of a size matching the display device 20 connected to the information processing device 10 is arranged in a virtual space, a user of the information processing device 10b connected to a stereoscopic display overlooks the stage to confirm the position of an item and control virtual character B to point to that position, for example, and then, a user of the information processing device 10a connected to a VR display device operates virtual character A to move on the stage while searching for the item at the position pointed to by virtual character B.

Incidentally, in this example, the information processing device 10a or 10b determines whether or not the virtual character controlled by the information processing device 10a or 10b has a relatively large body size, by referring to the parameter database of the server device 30 when acquiring size information Z of the virtual character controlled by the information processing device 10a or 10b. That is, the information processing device 10 collects parameter information regarding the body size of the virtual character controlled by another information processing device 10 that is playing a game by sharing setting information regarding the virtual space. Then, the information processing device 10 obtains an average Av of the body sizes of the virtual characters controlled by the other information processing device 10, and, in a case where the previously acquired body size Z of the virtual character which is under control of the information processing device 10 is larger than the average Av (in the case of Z>Av), a limit value for the amount of movement or change that can be made at one time is obtained.

Here, for example, the limit value may be determined on the basis of the difference Z-Av between the body size Z of the virtual character which is under control of the information processing device 10 and the average Av of the body sizes of the virtual characters controlled by the other information processing device 10. As an example, r=f(Z−Av) (where Z>Av) is calculated by using a predetermined monotonically increasing function f(x)=−Exp[−(x/100)]+1. Then, for example, the limit αlimit may be determined as αlimit=αmax−r·αmax for the maximum change amount omax that can be specified for the pose information regarding the shoulder joint. In an example using the above function, r is approximately 0.6 when Z−Av=99. In other words, for the virtual character controlled by the information processing device 10b, the maximum change amount of the pose or movement amount per unit time is limited to 0.6 times that of the virtual character controlled by another information processing device.

The information processing device 10b in this example calculates δx=Δα−αlimit in a case where the provisionally determined change amount Δα exceeds the limit value αlimit determined here. Then, the information processing device 10b uses this value dx to calculate T=[Δα/αlimit]+1 (where [X] is the maximum integer not exceeding X).

Next, the information processing device 10b calculates the angle of the shoulder joint of the virtual character at each predetermined time as α+Δx×i/T (i=1, 2, . . . . T) for T times, with the amount of change in the angle of the shoulder joint per one time being Δα/T, and requests the server device 30 to set the angle of the shoulder joint of the virtual character B which is under control of the information processing device 10b to the angle to be obtained after the change, in the virtual space information held by the server device 30.

According to this example, a relatively large-sized virtual character is controlled to move relatively slowly in the game space compared to other relatively small-sized virtual characters.

This allows a relatively large virtual character to move largely at a relatively fast speed in the virtual space, or to change poses relatively quickly, thereby reducing VR sickness of a user viewing the virtual space in VR or the like.

### [Time Averaging]

Further, the information processing device 10 may perform time averaging (filtering) on the instructions input by the user's operation, when changing the body size of a virtual character arranged and controlled by the information processing device 10, in accordance with the type of the display device 20 connected to the information processing device 10, and determining that the body size is relatively large.

In this example, the information processing device 10 stores the movement amounts (Δx, Δy, Δz) and pose change amounts 40 caused by user operations over the past N times (N is an integer of 2 or more, and may be determined depending on the body size of the virtual character such that N is larger as the size increases), for example, calculates the average thereof, and sets the average as the user's instruction. In this example, when a user A of the information processing device 10a connected to the display device 20a, which is a VR display device, looks at a virtual character operated by a user B of the information processing device 10b connected to the display device 20b, which is a stereoscopic display, for example, the situation in which the shaking of the user B's hand is significantly reflected in the virtual character of the user B, which is displayed in a relatively large size due to the scale is alleviated.

### [Correction of Arrangement Position]

In addition, the distance between the left and right eyes varies depending on the size of the virtual character, and the sense of distance felt by a small virtual character may not correspond to the actual arrangement position. In view of this, the control section 11 of the information processing device 10 collects information regarding the body size parameters of virtual characters controlled by another information processing device 10 that are playing a game by sharing the setting information regarding the virtual space, and selects, as a reference size Sd, the smallest size among the collected sizes and a size Ss of the virtual character which is under control of the control section 11. After determining the arrangement position of the virtual character which is under control of the control section 11, the control section 11 corrects the arrangement position such that the distance between the arrangement position and the smallest virtual character is shortened by α×(Ss−Sd) (a is a constant determined experimentally), and arranges the virtual character which is under control of the control section 11, at the corrected arrangement position.

### REFERENCE SIGNS LIST

1: Information processing system
10: Information processing device
11: Control section
12: Storage section
13: Operation control section
14: Display control section
15: Communication section
20: Display device
21: HMD
22: Control unit
30: Server device
31: Viewpoint detection unit
32: Parallax image generation section
33: Parallax image display section
41: Application executing section
42: Information communicating section
43: Character control section
44: Virtual space setting section

1. An information processing device that is connected to a display device of a first type and that is communicably connected to another information processing device which is connected to a display device of a type different from the display device of the first type, the information processing device comprising:
processing circuitry configured to
access setting information regarding a virtual space shared with the other information processing device,
arrange a virtual character in the virtual space represented by the setting information, and
arrange the virtual character by using a parameter that is determined according to the type of the display device connected to the information processing device.

2. The information processing device according to claim 1, wherein
the parameter determined according to the type of the display device includes a parameter related to a body size of the virtual character in the virtual space.

3. The information processing device according to claim 2, wherein the processing circuitry is further configured to
execute processing for a pose change or movement of the virtual character arranged in the virtual space, and
when having changed the parameter related to the body size of the virtual character, control the pose change or movement of the virtual character having a first body size by setting an upper limit on a speed of the pose change or movement of the virtual character.

4. The information processing device according to claim 2, wherein the processing circuitry is further configured to
receive an instruction from a user for a pose change or movement of the virtual character arranged in the virtual space,
execute processing for the pose change or movement of the virtual character based on the instruction, and
when having changed the parameter related to the body size of the virtual character, determine an amount of the pose change or movement of the virtual character having a first body size by averaging an amount of change or movement based on the instruction per unit time, and execute processing for the pose change or movement of the virtual character by using the determined amount of change or movement.

5. The information processing device according to claim 2, wherein the processing circuitry is further configured to
acquire a body size of a virtual character arranged by the other information processing device, and
when changing the parameter related to the body size, compare the acquired body size of the virtual character arranged by the other information processing device with the body size of the virtual character arranged by the processing circuitry, and correct an arrangement position of a character having a first body size in the virtual space with a character having a second body size smaller than the first body size as a reference size.

6. An information processing system, comprising:
a plurality of information processing devices connected to display devices of first and second types that are different from each other, respectively,
wherein each of the information processing devices include processing circuitry configured to
access setting information regarding a virtual space shared with another information processing device,
arrange a user-controllable virtual character in the virtual space represented by the setting information, and
arrange the virtual character by using a parameter that is determined according to the type of the display device connected to the information processing device.

7. A method for controlling an information processing device that is connected to a display device of a first type and that is communicably connected to another information processing device which is connected to a display device of a type different from the display device of the first type, the method comprising:
accessing setting information regarding a virtual space shared with the other information processing device;
arranging a virtual character in the virtual space represented by the setting information; and
arranging the virtual character by using a parameter determined according to the type of the display device connected to the information processing device.

8. A non-transitory computer-readable storage medium storing a program for an information processing device that is connected to a display device of a first type and that is communicably connected to another information processing device which is connected to a display device of a type different from the display device of the first type which, when executed by a computer, causes the computer to perform a method, the method comprising:
accessing setting information of a virtual space shared with the other information processing device;
arranging a virtual character in the virtual space represented by the setting information; and
arranging the virtual character by using a parameter determined according to the type of the display device connected to the information processing device.

9. The non-transitory computer-readable storage medium of claim 8, wherein the parameter determined according to the type of the display device includes a parameter related to a body size of the virtual character in the virtual space.

10. The non-transitory computer-readable storage medium of claim 9, further comprising:
executing processing for a pose change or movement of the virtual character arranged in the virtual space; and
in a case that the parameter related to the body size of the virtual character is changed, controlling the pose change or movement of the virtual character having a first body size by setting an upper limit on a speed of the pose change or movement of the virtual character.

11. The non-transitory computer-readable storage medium of claim 9, further comprising:
receiving an instruction from a user for a pose change or movement of the virtual character arranged in the virtual space;
executing processing for the pose change or movement of the virtual character based on the instruction; and
in a case that the parameter related to the body size of the virtual character is changed, determining an amount of the pose change or movement of the virtual character having a first body size by averaging an amount of change or movement based on the instruction per unit time, and executing processing for the pose change or movement of the virtual character by using the determined amount of change or movement.

12. The non-transitory computer-readable storage medium of claim 9, further comprising:
acquiring a body size of a virtual character arranged by the other information processing device; and
in a case that the parameter related to the body size is changed, comparing the acquired body size of the virtual character arranged by the other information processing device with the body size of the virtual character arranged by the information processing device, and correcting an arrangement position of a character having a first body size in the virtual space with a character having a second body size smaller than the first body size as a reference size.

13. The method of claim 7, wherein the parameter determined according to the type of the display device includes a parameter related to a body size of the virtual character in the virtual space.

14. The method of claim 13, further comprising:
acquiring a body size of a virtual character arranged by the other information processing device; and
in a case that the parameter related to the body size is changed, comparing the acquired body size of the virtual character arranged by the other information processing device with the body size of the virtual character arranged by the information processing device, and correcting an arrangement position of a character having a first body size in the virtual space with a character having a second body size smaller than the first body size as a reference size.

15. The information processing system of claim 6, wherein the parameter determined according to the type of the display device includes a parameter related to a body size of the virtual character in the virtual space.

16. The information processing system of claim 15, further comprising:
acquire a body size of a virtual character arranged by the other information processing device, and
when changing the parameter related to the body size, compare the acquired body size of the virtual character arranged by the other information processing device with the body size of the virtual character arranged by the respective information processing device, and correct an arrangement position of a character having a first body size in the virtual space with a character having a second body size smaller than the first body size as a reference size.
